(19) United States
(12) Patent Application Publication
(10) Pub. No.: US 2016/0110520 A1
(43) Pub. Date: Apr. 21, 2016

(54) Calculating Treatment Response for a Patient

(71) Applicant: International Business Machines Corporation, Armonk, NY (US)

(72) Inventors: Elizabeth T. Dettman, Rochester, MN (US); Andrew R. Freed, Cary, NC (US); Michael T. Payne, Rochester, MN (US); Michael W. Schroeder, Rochester, MN (US)

(21) Appl. No.: 14/516,502

(22) Filed: Oct. 16, 2014

(51) Int. Cl. G06F 19/00

(52) U.S. Cl. CPC G06F 19/3475; G06F 19/363; G06F 19/3406

(57) ABSTRACT

An approach is provided in which a knowledge manager selects patient data measurements corresponding to a patient that is on a current treatment plan. The patient data measurements correspond to different test results of the patient. The knowledge manager analyzes the patient data measurements against guideline threshold compilations that include multiple guideline thresholds. In turn, the knowledge manager determines a patient response of the patient and chronologically maps the patient response to the treatment plan.

BACKGROUND

A patient with a chronic disease may see multiple caregivers over a span of the chronic disease. Unfortunately, a lack of communication may exist between the different caregivers, which increase the complexity of the patient's diagnosis. In addition, chronic disease treatment plans are often complicated and require numerous tests at frequent intervals. For example, caregivers of a leukemia patient may monitor the patient's measurements of bone marrow, blood blasts, platelets, hemoglobin, and absolute neutrophil count (ANC), etc. on a weekly or monthly basis to assess the response status of the patient. As a result, tracking patient responses to a treatment plan become cumbersome.

### BRIEF SUMMARY

According to one embodiment of the present disclosure, an approach is provided in which a knowledge manager selects patient data measurements corresponding to a patient that is on a current treatment plan. The patient data measurements correspond to different test results of the patient. The knowledge manager analyzes the patient data measurements against guideline threshold compilations that include multiple guideline thresholds. In turn, the knowledge manager determines a patient response of the patient and chronologically maps the patient response to the treatment plan.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 depicts a schematic diagram of one illustrative embodiment of a knowledge manager system in a computer network;

FIG. 2 illustrates an information handling system, more particularly, a processor and common components, which is a simplified example of a computer system capable of performing the computing operations described herein;

FIG. 3 is an exemplary diagram depicting a knowledge manager system that compares patient data measurements against guideline threshold measurements to determine a patient's response and chronologically map the patient's response to the patient's treatment plan;

FIG. 4 is an exemplary diagram depicting various guideline threshold compilations for MDS;

FIG. 5 is an exemplary diagram depicting a cumulative response graph of a patient under a particular treatment plan;

FIG. 6 is an exemplary diagram depicting patient responses over time and the knowledge manager determining whether the patient has sustained a response;

FIG. 7 is an exemplary flowchart depicting steps taken by a knowledge manager to analyze measurement guidelines and create compartmentalized guideline threshold compilations that the knowledge manager utilizes to assess a patient's response progress to a treatment plan; and

FIG. 8 is an exemplary flowchart depicting steps taken by a knowledge manager to determine patient responses of treatments based upon patient data.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

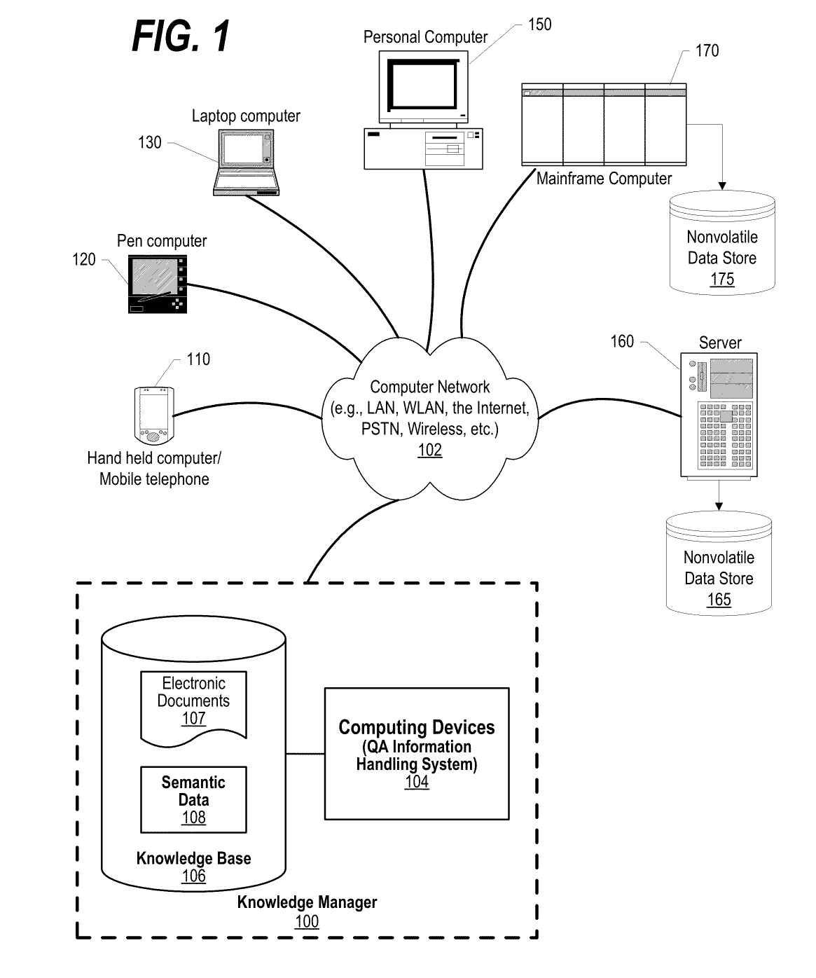

FIG. 1 depicts a schematic diagram of one illustrative embodiment of a question/answer creation (QA) system 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 106 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 100. The document 106 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

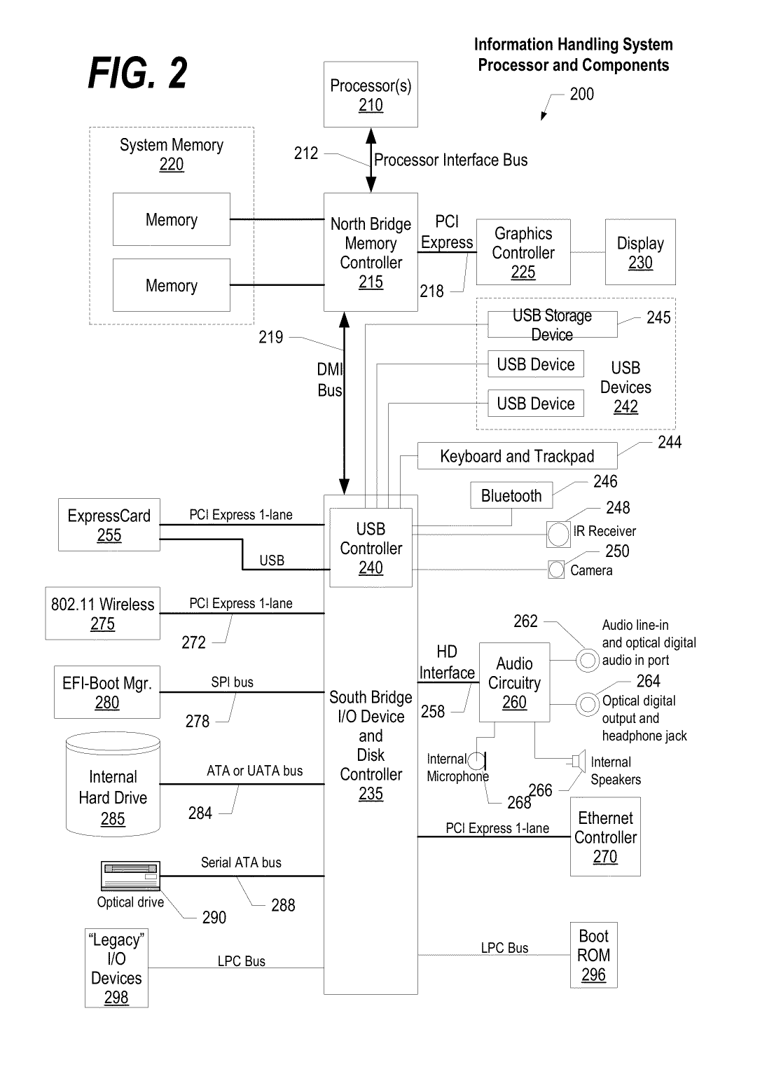

Types of information handling systems that can utilize knowledge manager 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE .802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

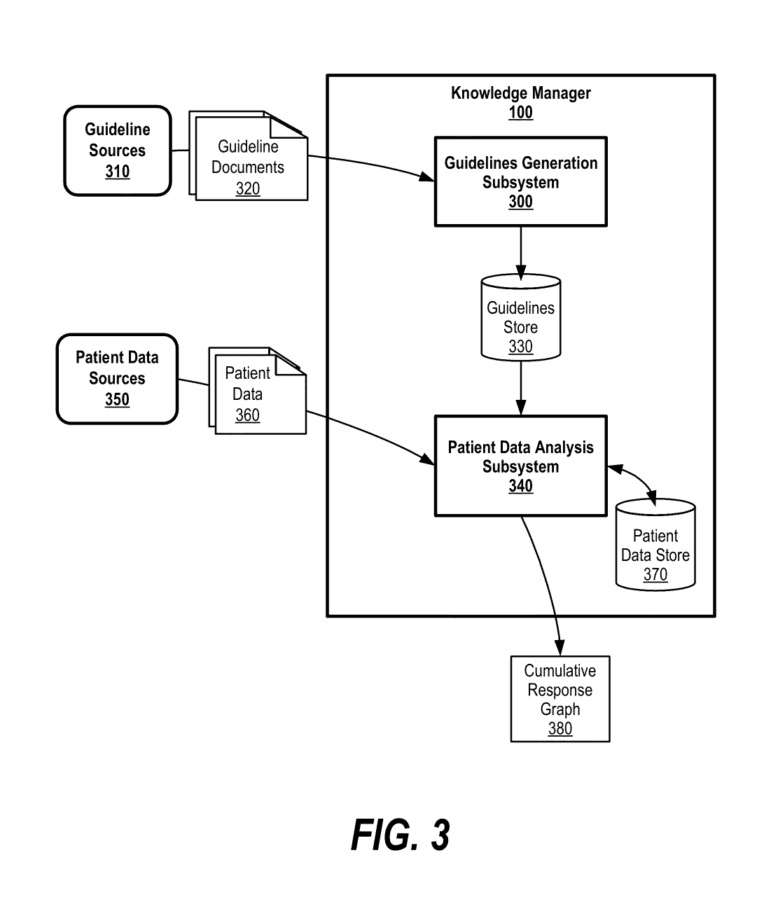

FIGS. 3-8 depict an approach that can be executed on an information handling system, which analyzes a compilation of patient data measurements against a compilation of guideline thresholds to chronologically determine a patient response of a patient that is on a particular treatment plan. The information handling system also tracks the patient's response over time to determine whether the patient achieves a sustained response.

FIG. 3 is an exemplary diagram depicting a knowledge manager system that compares patient data measurements against guideline threshold measurements to determine a patient's response and chronologically map the patient's response to the patient's treatment plan.

Knowledge manager 100 includes guidelines generation subsystem 300, which receives guideline documents 320 from guideline sources 310. Guideline sources 310 may be, for example, magazines, publishers, doctor committees, medical teams, etc., and guidelines documents 320 may include journals, text books, patient surveys, study group data, etc. In one embodiment, guidelines generation subsystem 300 individually analyzes guidelines documents 320 for a particular disease, such as for myelodysplastic syndromes (MDS).

Guidelines generation subsystem 300 parses guideline documents 320 into guidelines segments, which guidelines generation subsystem 300 analyzes on an individual basis. In turn, guidelines generation subsystem 300 generates guideline threshold compilations from the guideline segments and links the guideline threshold compilations to overall patient responses of a patient. In one embodiment, guidelines generation subsystem 300 hard codes “calculator modules” based on the guideline documents. In this embodiment, knowledge manager 100 uses the calculator modules that correspond to the diagnosis of the patient before a therapy. As such, knowledge manager 100 analyzes each therapy for a patient, utilizing the appropriate treatment response calculator, to determine the response timeline (discussed below).

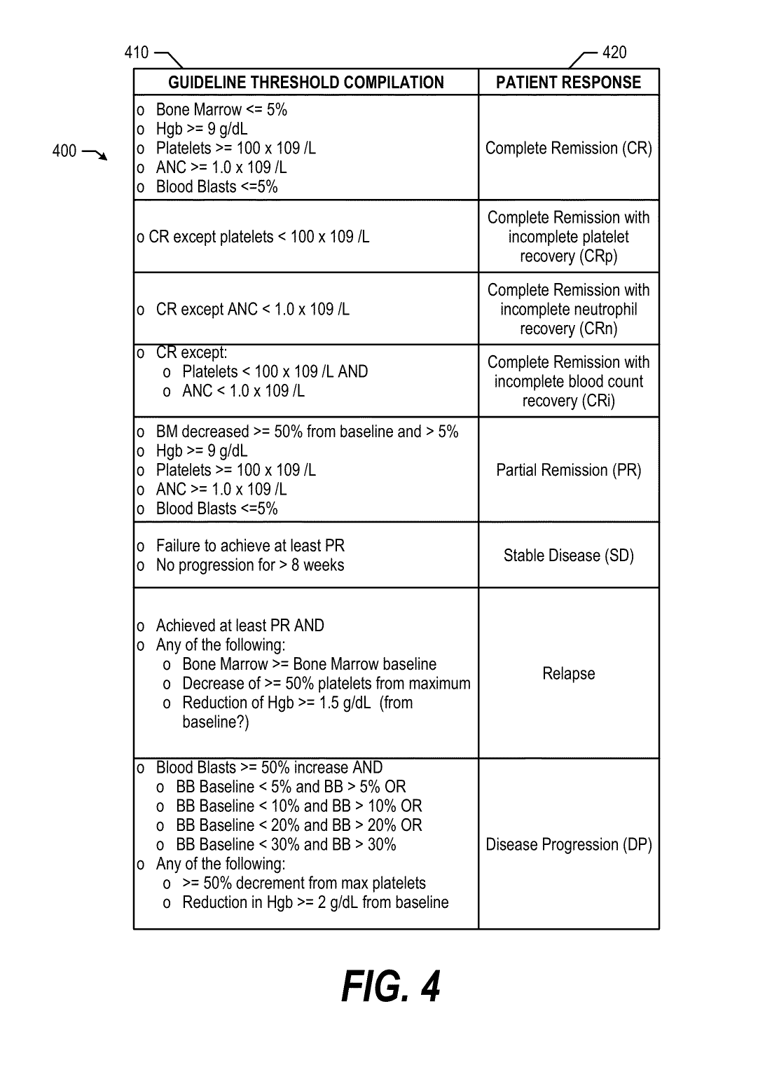

In another embodiment, certain guideline documents may discuss particular data relative to a particular disease. For example, one of the guideline documents 320 may discuss blood blasts relative to a disease while another one of the guideline documents 320 may discuss bone marrow percentage relative to the same disease. In this example, guidelines generation subsystem 300 identifies blood blast levels and bone marrow levels of a patient at various patient response points (complete remission, partial remission, etc.) and combines them into a guideline threshold compilation for the various patient responses. Guidelines generation subsystem 300 stores the guidelines threshold compilations in guidelines store 330 (see FIG. 4 and corresponding text for further details).

Patient data analysis subsystem 340 receives patient data 360 from various patient data sources 350. For example, patient data sources 350 may include various doctors, labs, etc., and patient data 360 may include various data measurements from various test results and observations. Patient data analysis subsystem 340 parses patient data 360 (if required) into individual patient data measurements and analyzes the patient data measurements against the guideline threshold compilations stored in guidelines store 330.

In one embodiment, patient data analysis subsystem 340 analyzes a patient's baseline measurements prior to a particular treatment plan. In another embodiment, patient data analysis subsystem 340 evaluates new patient data measurements alongside prior patient data measurements to determine an overall patient response of the patient. For example, the patient may have received new blood blast test results and patient data analysis subsystem 340 analyzes the new blood blast test results in combination with prior bone marrow percentage test results.

Patient data analysis subsystem 340 generates a patient data compilation and compares the patient data compilation against the guideline threshold compilations to determine an overall patient response of the patient. For example, if a bone marrow blasts before a treatment is above a “Complete Remission” threshold and the bone marrow blasts during treatment reached below the Complete Remission threshold, patient data analysis subsystem 340 determines that patient response is a Complete Remission response.

As such, patient data analysis subsystem 340 stores a patient response identifier and a response analysis date in patient data store 370. In one embodiment, patient data analysis subsystem 340 also stores key patient data measurement information, such as a bone marrow percentage test result and the date of the test.

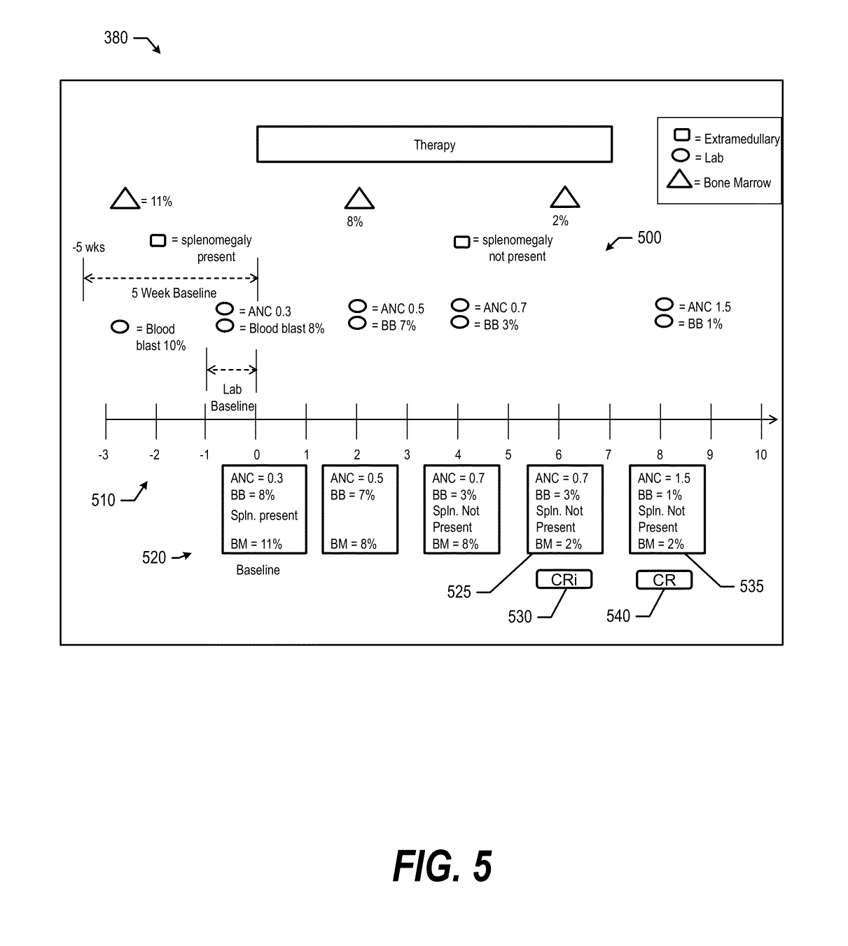

Over the course of a treatment plan, patient data analysis subsystem 340 receives patient data 360 at various time intervals. Patient data analysis subsystem 340 analyzes the new patient data against the guideline threshold compilations and stores a corresponding patient response identifier in patient data store 370. In turn, patient data analysis subsystem 340 generates a patient response history over the course of the treatment plan and includes the patient response history in cumulative response graph 380. In one embodiment, cumulative response graph 380 chronologically maps key patient data measurements alongside the patient response identifiers, such as that shown in FIG. 5.

FIG. 4 is an exemplary diagram depicting various guideline threshold compilations for MDS. In one embodiment, knowledge manager 100 may generate more or less patient response guideline threshold compilations based upon guideline documents 320. In another embodiment, knowledge manager 100 generates individual guideline threshold compilations on a per-disease basis such as for Acute myeloid leukemia (AML) and Acute Lymphoblastic Leukemia (ALL).

Table 400 includes guideline threshold compilations in column 410 and patient response identifiers in column 420. As such, when knowledge manager 100 matches patient data compilations to one of the guideline threshold compilations in column 410, knowledge manager 100 stores the corresponding patient response identifier from column 420 in patient data store 370 along with a response analysis date.

FIG. 5 is an exemplary diagram depicting a cumulative response graph of a patient under a particular treatment plan. Cumulative response graph 380 includes patient data measurement area 500 chronologically ordered according to timeline 510.

Cumulative response graph 380 also includes patient data compilation area 520 that includes compilations of the patient data as knowledge manager 100 receives and analyzes new patient data. Patient data compilation 525 includes new patient data measurements of bone marrow data taken in week 6 (2%) and also includes prior patient data measurements from week 4 for ANC (0.7) and blood blast (3%). Knowledge manager 100 analyzed patient data compilation 525 against guideline measurement thresholds (e.g., table 400) to determine a patent response that patient response identifier 530 represents.

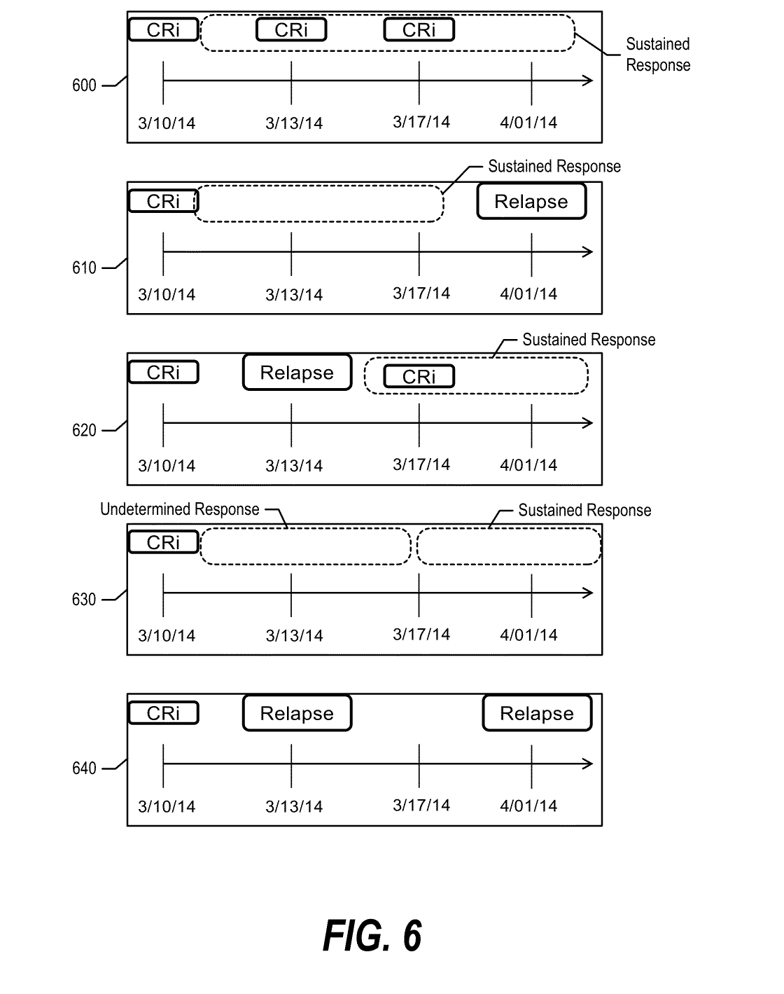

Similarly, knowledge manager 100 analyzed patient data compilation 535, which includes new patient data measurements from week 8 to determine a patient response that patient response identifier 540 represents. As such, a caregiver may view cumulative response graph 380 and assess the patient's response over time (see FIG. 6 and corresponding text for further details).

FIG. 6 is an exemplary diagram depicting patient responses over time and the knowledge manager determining whether the patient has sustained a response. In one embodiment, knowledge manager 100 identifies the criteria for determining a sustained response from guidelines documents 300.

Timeline 600 indicates that if knowledge manager 100 receives patient data within the next seven days and does not result in a major change in patient response, then the knowledge manager determines that the patient sustains the patient response.

Timeline 610 indicates that if knowledge manager 100 does not receive patient data within the next seven days, but receives more patient data beyond seven days, then the knowledge manager determines that the patient sustains the patient response.

Timeline 620 indicates that if knowledge manager 100 determines a relapse patient response within seven dates after a CRx (CRi) response and the relapse patient response is not sustained for seven days, then the knowledge manager determines that the patient sustains the CRx patient response.

Timeline 630 indicates that if the current date is at least two weeks from the patient response date and is the last date with patient data, knowledge manager 100 assumes that knowledge manager 100 will not receive patient data within seven days from the response date and the response is sustained. If the current date less than two weeks from the response date and is the last date with patient data, knowledge manager 100 does not assume there will be no patient data within seven days from the response date and does not determine whether response is sustained.

Timeline 640 indicates that if there is a relapse patient response within seven days after a CRx response and the relapse patient response is sustained for seven days, then the CRx response is not sustained.

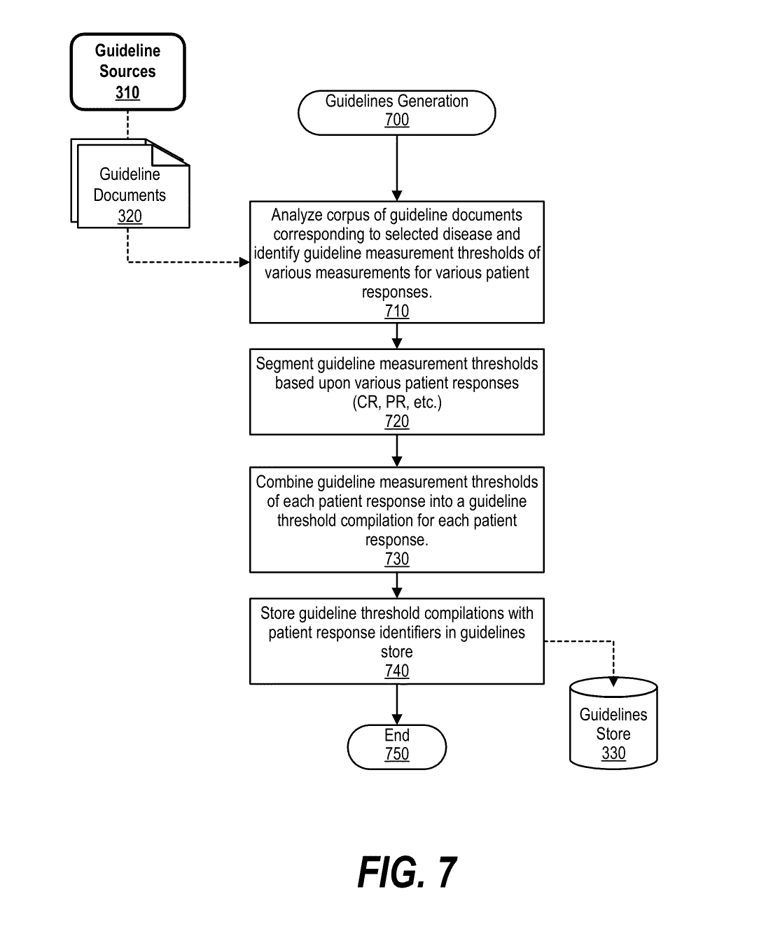

FIG. 7 is an exemplary flowchart depicting steps taken by a knowledge manager to analyze measurement guidelines and create compartmentalized guideline threshold compilations that the knowledge manager utilizes to assess a patient's response progress to a treatment plan.

Processing commences at 700, whereupon the process analyzes a corpus of guideline documents corresponding to a selected disease and identifies guideline measurement thresholds of various measurements for various patient responses at step 710. For example, guideline documents 720 may include journals, text books, patient surveys, study group data, etc., for MDS, which the process analyzes to identify guideline measurement thresholds of measurements such as bone marrow percentage, Hgb, Platelets, ANC, and blood blasts. In one embodiment, the process utilizes natural language processing to ingest guideline documents 720 into a domain for subsequent access.

At step 720, the process segments the guideline measurement thresholds based upon various guideline responses such as those included the guideline documents (CR, PR, etc.). At step 730, the process combines the guideline measurement thresholds of each patient response into a guideline threshold compilation for each patient response. At step 740, the process stores the guideline threshold compilations with response identifiers in guidelines store. FIG. 4 shows examples of various guideline threshold compilations and corresponding response identifiers. FIG. 7 processing thereafter ends at 750.

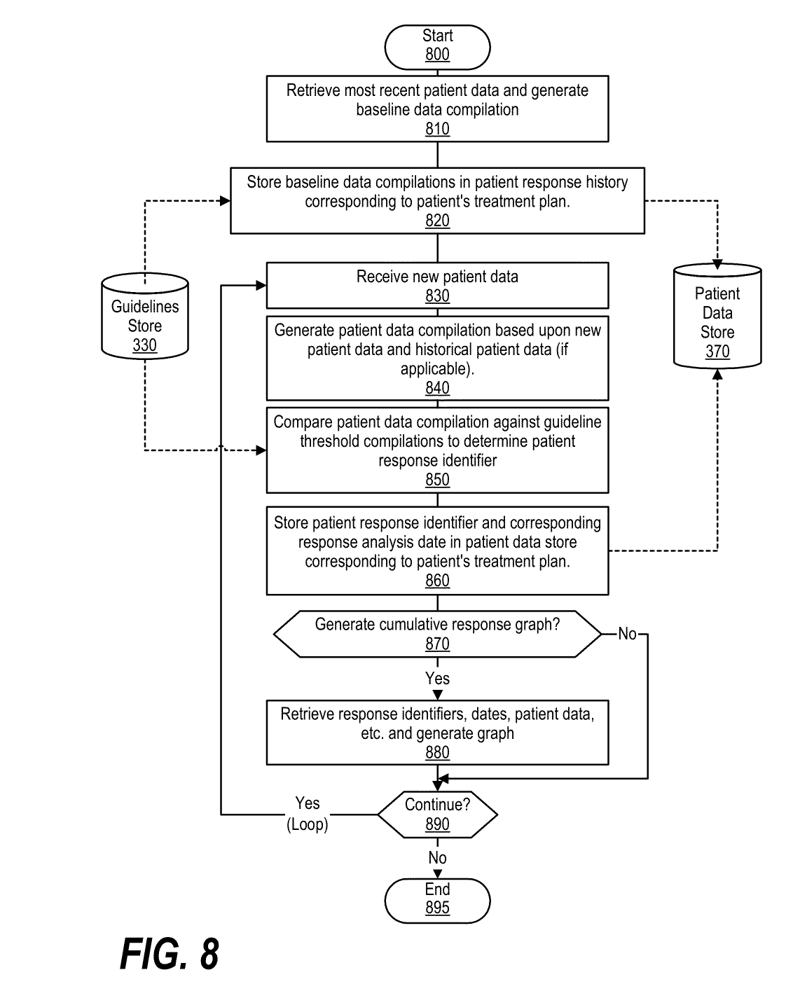

FIG. 8 is an exemplary flowchart depicting steps taken by a knowledge manager to determine patient responses of treatments based upon patient data. Processing commences at 800, whereupon the process retrieves a set of a patient's most recent patient data measurements and generates a baseline data compilation at step 810. For example, some patient measurements may be a few weeks old and some patient measurements may be a few months old.

At step 820, the process stores the baseline data compilation in the patient's response history corresponding to patient's treatment plan. As such, the process may refer back to the baseline data compilation or one or more specific baseline measurements of the patient for subsequent analysis of patient responses.

At step 830, the process receives new patient data, such as from a new patient test. At step 840, the process analyzes the new patient data and generates a patient data compilation based upon the new patient data and historical patient data if applicable. For example, the new patient data may include a bone marrow measurements and the process uses the bone marrow measurement along with previous patient measurements (blood blasts, etc.) to generate the patent data compilation.

At step 850, the process compares the patient data compilation against the guideline threshold compilations to determine a patient response identifier. At step 860, the process stores the patient response identifier and a corresponding response analysis date (e.g., date of the most recent test result or the date of the analysis) in the patient's treatment plan. The process determines as to whether to generate a cumulative response graph, such as that shown in FIG. 5 (decision 870). The cumulative response graph provides a visual indication of the patient's response progression over time while the patient is on a particular treatment plan.

If the process should generate a cumulative response graph, then decision 870 branches to the ‘yes’ branch whereupon, at step 880, the process retrieves response identifiers, dates, patient data, etc. and generates the cumulative response graph. On the other hand, if the process should not generate a cumulative response graph, then decision 870 branches to the ‘no’ branch.

The process determines as to whether continue receiving and processing patient data (decision 890). If the process should continue, then decision 890 branches to the ‘yes’ branch which loops back to receive and process the patient data. On the other hand, if the process should not continue, then decision 890 branches to the ‘no’ branch. FIG. 8 processing thereafter ends at 895.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by a knowledge manager system that includes a memory and a processor, the method comprising:
ingesting, by the processor, a plurality of patient data measurements into the knowledge manager system, wherein the plurality of patient data measurements correspond to a patient on a treatment plan;
comparing the plurality of patient data measurements against a plurality of guideline threshold compilations generated by the knowledge manager system, wherein each of the guideline threshold compilations comprise a plurality of guideline thresholds;
identifying a patient response from a plurality of patient responses based upon the comparing, wherein the patient response corresponds to a selected one of the plurality of guideline threshold compilations; and
chronologically mapping the identified patient response to the treatment plan.

2. The method of claim 1 further comprising:
selecting a patient response identifier that corresponds to the patient response;
determining a response analysis date of the patient response based upon one or more measurement dates corresponding to the plurality of patient data measurements; and
generating a cumulative response graph that graphs the patient response identifier on a timeline based upon the response analysis date.

3. The method of claim 2 further comprising:
adding the patient data compilation to the cumulative response graph based upon the analysis date.

4. The method of claim 1 further comprising:
identifying a plurality of baseline data measurements taken prior to the commencement of the treatment plan; and
including at least one of the plurality of baseline data measurements in the selected plurality of patient data measurements.

5. The method of claim 1 further comprising:
receiving a corpus of guideline documents from a plurality of sources;
parsing the corpus of guideline documents into the plurality of guideline thresholds; and
grouping the plurality of guideline thresholds into the plurality of guideline measurement compilations based upon the plurality of patient responses.

6. The method of claim 1 wherein at least one of the plurality of patient responses is selected from the group consisting of a complete remission response, a complete remission with incomplete platelet recovery, a complete remission with incomplete neutrophil recovery, a complete remission with incomplete blood count recovery, a partial remission, a stable disease, a relapse, and a disease progression.

7. The method of claim 1 further comprising:
performing natural language processing on a plurality of patient documents from a plurality of sources, wherein the natural language processing results in at least a portion of the plurality of patient data measurements.

8. The method of claim 1 further comprising:
determining that the patient response is a sustained response at a point in time based upon the patient response and one or more subsequent patient responses relative to the point in time.

9. An information handling system comprising:
one or more processors;
a memory coupled to at least one of the processors; and
a set of computer program instructions stored in the memory and executed by at least one of the processors in order to perform actions of:
ingesting a plurality of patient data measurements into the information handling system, wherein the plurality of patient data measurements correspond to a patient on a treatment plan;
comparing the plurality of patient data measurements against a plurality of guideline threshold compilations generated by the information handling system, wherein each of the guideline threshold compilations comprise a plurality of guideline thresholds;
identifying a patient response from a plurality of patient responses based upon the comparing, wherein the patient response corresponds to a selected one of the plurality of guideline threshold compilations; and
chronologically mapping the identified patient response to the treatment plan.

10. The information handling system of claim 9 wherein the one or more processors perform additional actions comprising:
selecting a patient response identifier that corresponds to the patient response;
determining a response analysis date of the patient response based upon one or more measurement dates corresponding to the plurality of patient data measurements; and
generating a cumulative response graph that graphs the patient response identifier on a timeline based upon the response analysis date.

11. The information handling system of claim 10 wherein the one or more processors perform additional actions comprising:
adding the patient data compilation to the cumulative response graph based upon the analysis date.

12. The information handling system of claim 9 wherein the one or more processors perform additional actions comprising:
identifying a plurality of baseline data measurements taken prior to the commencement of the treatment plan; and
including at least one of the plurality of baseline data measurements in the selected plurality of patient data measurements.

13. The information handling system of claim 9 wherein the one or more processors perform additional actions comprising:
receiving a corpus of guideline documents from a plurality of sources;
parsing the corpus of guideline documents into the plurality of guideline thresholds; and
grouping the plurality of guideline thresholds into the plurality of guideline measurement compilations based upon the plurality of patient responses.

14. The information handling system of claim 9 wherein the one or more processors perform additional actions comprising:
performing natural language processing on a plurality of patient documents from a plurality of sources, wherein the natural language processing results in at least a portion of the plurality of patient data measurements.

15. A computer program product stored in a computer readable storage medium, comprising computer program code that, when executed by an information handling system, causes the information handling system to perform actions comprising:
ingesting a plurality of patient data measurements into the information handling system, wherein the plurality of patient data measurements correspond to a patient on a treatment plan;
comparing the plurality of patient data measurements against a plurality of guideline threshold compilations generated by the information handling system, wherein each of the guideline threshold compilations comprise a plurality of guideline thresholds;
identifying a patient response from a plurality of patient responses based upon the comparing, wherein the patient response corresponds to a selected one of the plurality of guideline threshold compilations; and
chronologically mapping the identified patient response to the treatment plan.

16. The computer program product of claim 15 wherein the information handling system performs additional actions comprising:
selecting a patient response identifier that corresponds to the patient response;
determining a response analysis date of the patient response based upon one or more measurement dates corresponding to the plurality of patient data measurements; and
generating a cumulative response graph that graphs the patient response identifier on a timeline based upon the response analysis date.

17. The computer program product of claim 16 wherein the information handling system performs additional actions comprising:
adding the patient data compilation to the cumulative response graph based upon the analysis date.

18. computer program product of claim 15 wherein the information handling system performs additional actions comprising:
identifying a plurality of baseline data measurements taken prior to the commencement of the treatment plan; and
including at least one of the plurality of baseline data measurements in the selected plurality of patient data measurements.

19. computer program product of claim 15 wherein the information handling system performs additional actions comprising:
receiving a corpus of guideline documents from a plurality of sources;
parsing the corpus of guideline documents into the plurality of guideline thresholds; and
grouping the plurality of guideline thresholds into the plurality of guideline measurement compilations based upon the plurality of patient responses.

20. computer program product of claim 15 wherein the information handling system performs additional actions comprising:
performing natural language processing on a plurality of patient documents from a plurality of sources, wherein the natural language processing results in at least a portion of the plurality of patient data measurements.
